(19) United States
(12) Patent Application Publication
(10) Pub. No.: US 2025/0348718 A1
(43) Pub. Date: Nov. 13, 2025

(54) METHOD AND DEVICE FOR GENERATING DATA

(71) Applicants: HYUNDAI MOTOR COMPANY, Seoul (KR); KIA CORPORATION, Seoul (KR)

(72) Inventor: Kyujin Park, Hwaseong-si (KR)

(73) Assignees: HYUNDAI MOTOR COMPANY, Seoul (KR); KIA CORPORATION, Seoul (KR)

(21) Appl. No.: 18/940,542

(22) Filed: Nov. 7, 2024

(30) Foreign Application Priority Data
May 9, 2024 (KR) 10-2024-0061069

(51) Int. Cl. G06N 3/0499; G06N 3/045

(52) U.S. Cl. CPC G06N 3/0499; G06N 3/045

(57) ABSTRACT

A method and a device for generating data may generate new data while constraining feature information unique to table-type data. The method includes: generating a constraint vector variable specifying a constraint specific to the table-type data; acquiring generated data by applying the constraint vector variable and a latent vector variable to a generator; discriminating whether the generated data is real data or fake data by applying original data and the generated data to a discriminator; predicting whether the generated data satisfies the constraint specific to the table-type data; and generating a predicted constraint vector variable based on a prediction result.

### CROSS-REFERENCE TO RELATED APPLICATION

This application claims priority to and the benefit of Korean Patent Application No. 10-2024-0061069 filed in the Korean Intellectual Property Office on May 9, 2024, the entire contents of which are incorporated herein by reference.

### BACKGROUND

### (a) Technical Field

The present disclosure relates to a method and a device for generating data.

### (b) Description of the Related Art

A generative model may generate new data by learning given data. In detail, a generative model may learn the distribution of a given data set and generate new data samples based on the learned distribution. Examples of the generative model may include generative adversarial network (GAN), variational auto-encoder (VAE), or diffusion. Various types of data such as images, voices, and texts may be generated using the generative model. In recent years, research has been conducted on a method to constrain generation to a specific type of data by the generative model.

### SUMMARY

The present disclosure provides a method and a device for generating data that may generate new data while constraining feature information unique to table-type data.

The present disclosure also provides a method and a device for generating data that may generate new data using each of the high-dimensional and the low-dimensional information as its constraint.

According to an embodiment, a method is provided for generating data. The method generates new data while constraining feature information unique to table-type data. The method includes: generating a constraint vector variable specifying a constraint specific to the table-type data; acquiring generated data by applying the constraint vector variable and a latent vector variable to a generator; discriminating whether the generated data is real data or fake data by applying original data and the generated data to a discriminator; predicting whether the generated data satisfies the constraint specific to the table-type data; and generating a predicted constraint vector variable based on a prediction result.

Acquiring the generated data may include converting the constraint vector variable to a low-dimensional vector through a first multilayer perceptron (MLP) embedding and may include converting the latent vector variable to the low-dimensional vector through a second MLP embedding.

Acquiring the generated data may further include additionally applying a feature vector variable to the generator together with the constraint vector variable. Converting the constraint vector variable to the low-dimensional vector through the first MLP embedding may include converting the constraint vector variable and the feature vector variable to the low-dimensional vectors through the first MLP embedding.

Acquiring the generated data may further include expanding information on the low-dimensional vector acquired from the first MLP embedding and the second MLP embedding and may include securing connectivity between the latent vector variable and the constraint vector variable.

Acquiring the generated data may further include calculating attention for each of a plurality of heads having different focusing aspects on a vector having expanded information through a multi-head attention network (MHAN) and may include outputting a final result by combining attention results with each other.

Acquiring the generated data may further include generating a specific type of result by analyzing the final result and acquiring the specific type of result as the generated data.

Discriminating may further include performing frame reshaping reconstruction on the generated data.

Discriminating may further include calculating attention for each of a plurality of heads having different focusing aspects on the reconstructed generated data through a MHAN and may include outputting a final result by combining attention results with each other.

Discriminating may further include performing feature extraction and conversion through a MLP and discriminating whether the generated data is the real data or the fake data based on results of the feature extraction and conversion.

The method may further include performing error measurement on the generated data and the predicted constraint vector variable through an error function based on mean squared error (MSE).

According to an embodiment, a device is provided for generating data. The device generates new data while constraining feature information unique to table-type data and executes a program code loaded in at least one memory device by at least one processor. The program code is executed to: generate a constraint vector variable specifying a constraint specific to the table-type data; acquire generated data by applying the constraint vector variable and a latent vector variable to a generator; discriminate whether the generated data is real data or fake data by applying original data and the generated data to a discriminator; predict whether the generated data satisfies the constraint specific to the table-type data and generate a predicted constraint vector variable based on a prediction result.

Acquiring the generated data may include converting the constraint vector variable to a low-dimensional vector through a first MLP embedding and may include converting the latent vector variable to the low-dimensional vector through a second MLP embedding.

Acquiring the generated data may include additionally applying a feature vector variable to the generator together with the constraint vector variable and may include converting the constraint vector variable to the low-dimensional vector through the first MLP embedding may include converting the constraint vector variable and the feature vector variable to the low-dimensional vectors through the first MLP embedding.

Acquiring the generated data may further include expanding information on the low-dimensional vector acquired from the first MLP embedding and the second MLP embedding and may include securing connectivity between the latent vector variable and the constraint vector variable. Acquiring the generated data may further include calculating attention for each of a plurality of heads having different focusing aspects on a vector having expanded information through a MHAN and may include outputting a final result by combining attention results with each other.

The acquiring the generated data may further include generating a specific type of result by analyzing the final result and acquiring the specific type of result as the generated data.

Discriminating may further include performing frame reshaping reconstruction on the generated data.

Discriminating may further include calculating attention for each of a plurality of heads having different focusing aspects on the reconstructed generated data through a MHAN and may include outputting a final result by combining attention results with each other.

Discriminating may further include performing feature extraction and conversion through a MLP and discriminating whether the generated data is the real data or the fake data based on results of the feature extraction and conversion.

The program code may perform error measurement on the generated data and the predicted constraint vector variable through an error function based on mean squared error (MSE).

### BRIEF DESCRIPTION OF THE DRAWINGS

FIG. 1 is a block diagram depicting a device for generating data according to an embodiment.

FIG. 2 is a flowchart of a method for generating data according to an embodiment.

FIG. 3 is a diagram of an implementation example of a device for generating data according to an embodiment.

FIG. 4 is a diagram of an implementation example of a device for generating data according to an embodiment.

FIGS. 5-7 are diagrams of an example of data generation by a device for generating data according to an embodiment.

FIG. 8 is a diagram of a computing device according to an embodiment.

### DETAILED DESCRIPTION

Hereinafter, embodiments of the present disclosure are described in detail with reference to the accompanying drawings so that those of ordinary skill in the art to which the present disclosure pertains may easily practice the present disclosure. However, the embodiments of the present disclosure may be implemented in various different forms and are not limited to the embodiments described herein. In addition, in the drawings, portions unrelated to the description have been omitted to more clearly describe aspects of the present disclosure, and similar portions are denoted by similar reference numerals throughout the specification.

Throughout the specification and claims, unless explicitly described otherwise, elements described as “including”, “having”, or “comprising” any components should be understood to imply the possible inclusion of another component rather than the exclusion of another component. Terms including ordinal numbers such as “first”, “second”, and the like, may be used to describe various components. However, these components are not limited by these terms. The terms are used only to distinguish one component and another component from each other.

When a component, device, element, module, or the like of the present disclosure is described as having a purpose or performing an operation, function, or the like, the component, device, element, module, or the like should be considered herein as being “configured to” meet that purpose or to perform that operation or function. Each component, device, element, module, or the like, may separately embody or be included with a processor and a memory, such as a non-transitory computer readable media, as part of the apparatus or device.

Terms such as “˜part”, “˜er/or”, and “module” described in the

specification may refer to a unit capable of processing at least one function or operation described in the specification, which may be implemented as hardware, a circuit, software, or a combination of hardware or circuit and software. In addition, at least some components or functions of the methods and the devices for generating data according to the embodiments described below may be implemented as a program or software, and the program or software may be stored in a computer-readable medium.

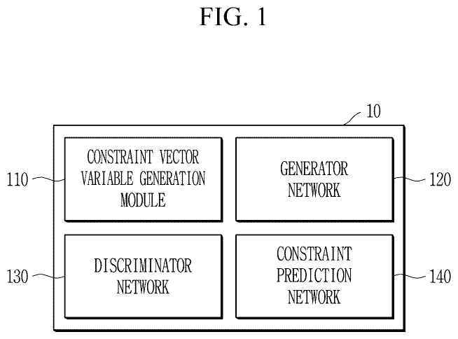

FIG. 1 is a block diagram depicting, and for explaining, a device for generating data according to an embodiment.

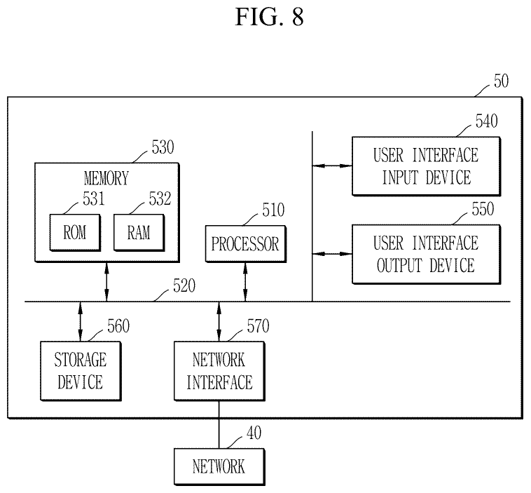

Referring to FIG. 1, a device 10 for generating data according to an embodiment may execute a program code loaded in at least one memory device by at least one processor. For example, the device 10 for generating data may be implemented as a computing device 50 as described below with reference to FIG. 8. In this case, at least one processor may correspond to a processor 510 of the computing device 50 and at least one memory device may correspond to a memory 520 of the computing device 50. The program code may be executed by at least one processor to thus generate new data while constraining feature information unique to table-type data or to generate the new data using each of the high-dimensional and the low-dimensional information as its constraint. In the specification, the term “module” is used to logically distinguish functions performed by the program codes.

The device 10 for generating data according to an embodiment may generate the new data while constraining the feature information unique to the table-type data. The table-type data may store various information in a structured form, include sparse feature information, and for example, variables or columns where most values are 0 or missing values. The device 10 for generating data may generate the new data while constraining the sparse feature information as mentioned above. To this end, the device 10 for generating data may execute the program code that includes a constraint vector variable generation module 110, a generator network 120, a discriminator network 130, and a constraint prediction network 140.

The constraint vector variable generation module 110 may generate a constraint vector variable that specifies a constraint specific to the table-type data. The constraint vector variable may be a condition variable for controlling a feature to be constrained in generating the data. For example, the constraint vector variable may be set to generate the data by setting a constraint for a specific position, a specific row, a specific column, or a specific area to certain table-type data.

The generator network 120 may perform learning until the generated data is discriminated as real data by the discriminator network 130 while generating the generated data based on the constraint vector variable generated by the constraint vector variable generation module 110 and a latent vector variable. Here, the latent vector variable may be an initial random variable that adds randomness to the data, which is converted to a specific dimension.

The discriminator network 130 may receive original data and the generated data provided from the generator network 120 and may discriminate whether the generated data is the real data or fake data. The discriminator network 130 may perform the learning until achieving high discrimination accuracy in determining authenticity of the generated data.

The constraint prediction network 140 may predict whether the generated data input to the discriminator network 130 satisfies the constraint specific to the table-type data. In addition, the constraint prediction network 140 may generate a predicted constraint vector variable based on a prediction result.

According to this embodiment, the device 10 may generate the new data while constraining the feature information unique to the table-type data and may generate the new data using each of the high-dimensional and the low-dimensional information as its constraint. For example, a certain conventional data generative model may be limited to generating an image while constraining the high-dimensional feature information. However, using the conventional model may be challenging because constraining the low-dimensional information, such as one pixel or several pixels, may lead to model overfitting. On the other hand, the device 10 according to the embodiments of the present disclosure, newly disclosed by adjusting an architecture of the generative model, may generate the data by constraining the high-dimensional information such as implicit semantic information in the table-type data, and simultaneously constraining the sparse feature information, i.e., low-dimensional information, in the table-type data.

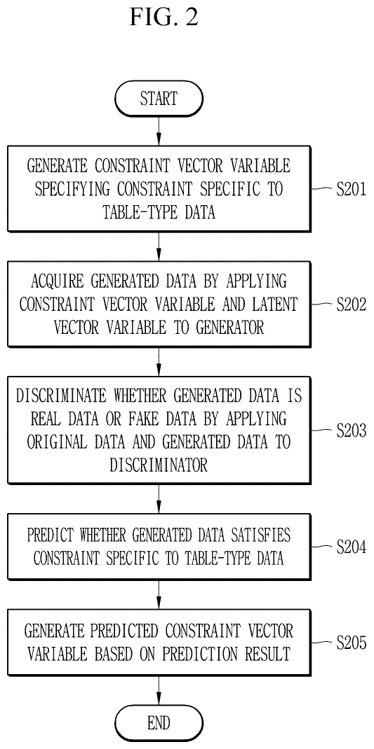

FIG. 2 is a flowchart of, and for explaining, a method for generating data according to an embodiment.

Referring to FIG. 2, the method for generating data according to an embodiment may include generating a constraint vector variable specifying a constraint specific to table-type data (step S201). The method may also include acquiring the generated data by applying the constraint vector variable and a latent vector variable to a generator (step S202). The method may also include discriminating whether the generated data is real data or fake data by applying original data and the generated data to a discriminator (step S203). The method may also include predicting whether the generated data satisfies the constraint specific to the table-type data (step S204). The method may also include generating a predicted constraint vector variable based on a prediction result (step S205).

The description may refer to the embodiments described in the specification for more detailed information on the method for generating data. Thus, a redundant description has been omitted here.

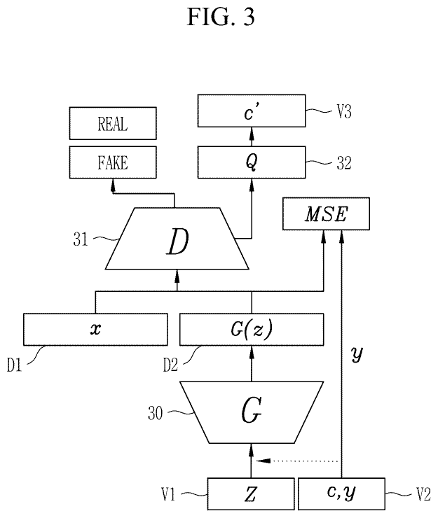

FIG. 3 is a diagram of, and for explaining, an implementation example of the device for generating data according to an embodiment.

Referring to FIG. 3, the device for generating data according an embodiment may include a generator network 30, a discriminator network 31, and a constraint prediction network 32.

In this implementation example, V1 may be provided with a vector latent variable Z and V2 may be provided with a constraint vector variable c specifying the constraint specific to the table-type data and a feature vector variable y. The vector latent variable Z, the constraint vector variable c, and the feature vector variable y may be input to the generator network 30.

The generator network 30 may output generated data G(z) based on the vector latent variable Z, the constraint vector variable c, and the feature vector variable y. The generated data G(z) and the feature vector variable y may be input to an error function to thus be used for the learning of the generator network 30. In some embodiments, the error function may be an error function based on mean squared error (MSE). The MSE may be a method of calculating the average of the squares of all differences to quantify differences between actual values and predicted values.

The discriminator network 31 may receive original data x and the generated data G(z) and may discriminate whether the generated data G(z) is the real data or the fake data.

The constraint prediction network 32 may predict whether the generated data G(z) satisfies the constraint specific to the table-type data and may generate a predicted constraint vector variable V3 from the prediction result.

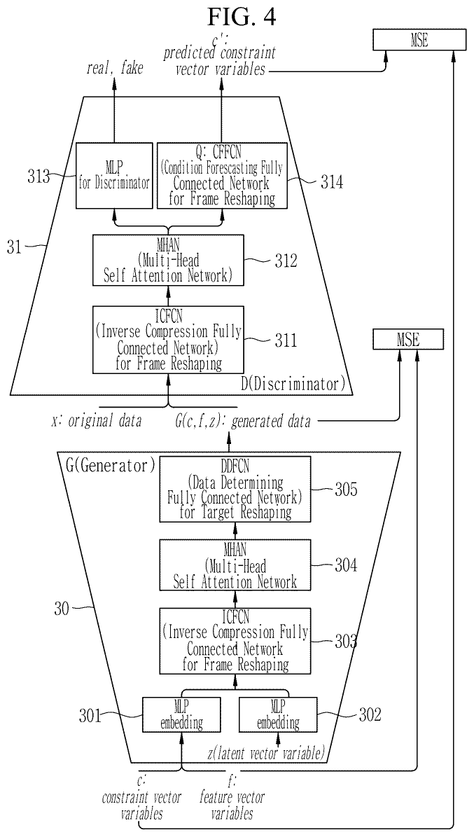

FIG. 4 is a diagram of, and for explaining, an implementation example of the device for generating data according to an embodiment.

Referring to FIG. 4, in the device for generating data according to an embodiment, the generator network 30 and the discriminator network 31 may be implemented using a plurality of fully connected networks.

In this implementation example, the generator network 30 may include a first multilayer perceptron (MLP) embedding 301, a second MLP embedding 302, an inverse compression fully connected network (ICFCN) 303, a multi-head attention network (MHAN) 304, and a data determining fully connected network (DDFCN) 305.

The generator network 30 may convert the constraint vector variable c and the feature vector variable y to low-dimensional vectors through the first MLP embedding 301. Meanwhile, the generator network 30 may convert a latent vector variable z to the low-dimensional vector through the second MLP embedding 302.

Next, the generator network 30 may expand information on the low-dimensional vectors acquired from the first MLP embedding 301 and the second MLP embedding 302 through the ICFCN 303. The generator network 30 may secure connectivity between the latent vector variable z and the constraint vector variable c.

Next, the generator network 30 may calculate attention for each of a plurality of heads having different focusing aspects on a vector having expanded information through the MHAN 304. The generator network 30 may output a final result by combining attention results with each other.

Next, the generator network 30 may generate a specific type of result by analyzing the final result through the DDFCN 305 and may output the specific type of result as generated data G(c, f, z). Error measurement may be performed on the generated data G(c, f, z) and the constraint vector variable c through the error function based on the MSE. The learning of the generator network 30 may be performed based on a result of the error measurement.

Further, the discriminator network 31 may include an ICFCN 311, an MHAN 312, an MLP 313, and a condition forecasting fully connected network (CFFCN) 314.

The discriminator network 31 may perform frame reshaping reconstruction on the original data x and the generated data G(c, f, z) through the ICFCN 311.

Next, the discriminator network 31 may calculate attention for each of a

plurality of heads having different focusing aspects through the MHAN on the reconstructed original data x and generated data G(c, f, z). The discriminator network 31 may output a final result by combining attention results with each other.

Next, the discriminator network 31 may perform feature extraction and conversion through the MLP 313 and may discriminate whether the generated data G(c, f, z) is the real data or the fake data based on results of the feature extraction and conversion.

Further, the discriminator network 31 may predict whether the generated data G(c, f, z) satisfies the constraint specific to the table-type data through the CFFCN 314. The discriminator network 31 may generate a predicted constraint vector variable c′ based on the prediction result. The error measurement may be performed on the constraint vector variable c and the predicted constraint vector variable c′ through the error function based on the MSE. The learning of the discriminator network 31 may be performed based on the result of the error measurement.

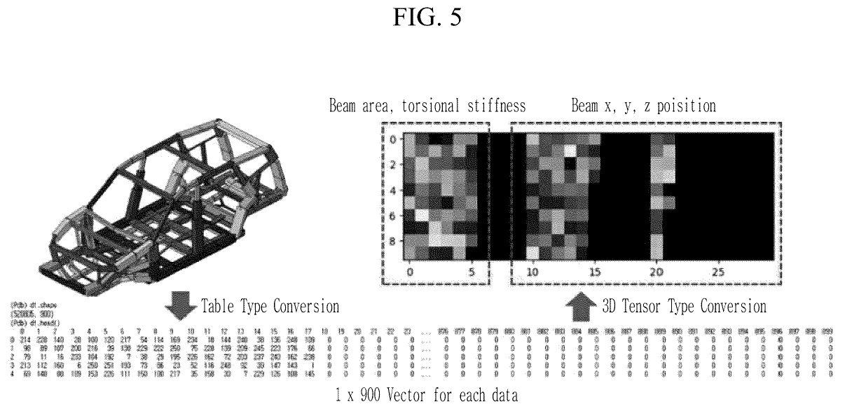

FIGS. 5-7 are diagrams of, and for explaining, an example of data generation by the device for generating data according to an embodiment.

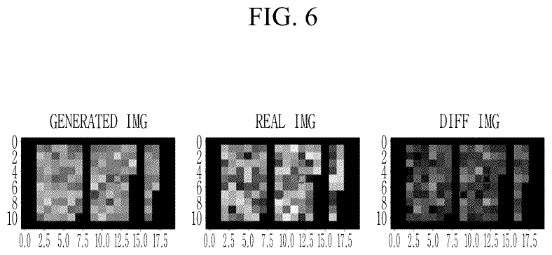

Referring to FIGS. 5 and 6, as an example of the data generation by the device for generating data according to an embodiment, the device may generate the data while constraining a specific feature value in the table-type data. This configuration overcomes the fact that the conventional generative model generally handles image data. Thus, it is challenging to apply the conventional model to the table-type data shown above or to generate the data while constraining the specific feature value.

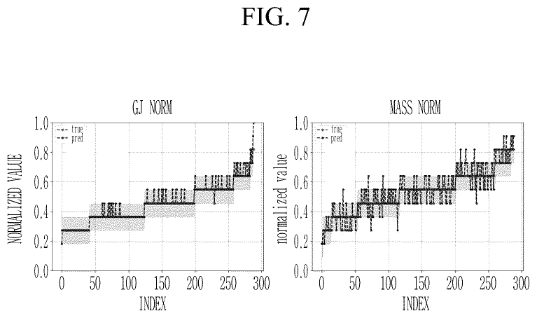

Next, referring to FIG. 7, it may be seen that the device 10 may generate the data that satisfies predictable information through data analysis such as stiffness or weight while constraining the specific feature value in the table-type data.

FIG. 8 is a diagram of, and for explaining, a computing device according to an embodiment.

Referring to FIG. 8, the method and device for generating data according to the embodiments may be implemented using the computing device 50.

The computing device 50 may include at least one of the processor 510, the memory 530, a user interface input device 540, a user interface output device 550, and a storage device 560, each performing their communications using a bus 520. The computing device 50 may also include a network interface 570 electrically connected to a network 40. The network interface 570 may transmit or receive a signal with another entity through the network 40.

The processor 510 may be implemented in any of various types such as a micro controller unit (MCU), an application processor (AP), a central processing unit (CPU), a graphic processing unit (GPU), a neural processing unit (NPU), or a quantum processing unit (QPU). The processor 510 may be any semiconductor device executing an instruction stored in the memory 530 or the storage device 560. The processor 510 may implement the functions and methods described above with respect to FIGS. 1-7.

The memory 530 and the storage device 560 may include various types of volatile or non-volatile storage media. For example, the memory may include a read-only memory (ROM) 531 and a random access memory (RAM) 532. In some embodiments, the memory 530 may be disposed inside or outside the processor 510 and may be connected to the processor 510 through various known means.

In some embodiments, at least some components or functions of the method and device for generating data according to the embodiments may be implemented as a program or software executed by the computing device 50. The program or software may be stored in the computer-readable medium. In detail, the computer-readable medium according to an embodiment may be a program for executing steps included in the method and device for generating data according to the embodiments recoded on a computer including the processor 510 executing the program or instruction stored in the memory 530 or the storage device 560.

In some embodiments, at least some components or functions of the method and device for generating data according to the embodiments may be implemented using hardware or circuitry of the computing device 50 or may be implemented using a separate hardware or circuitry that may be electrically connected to the computing device 50.

As set forth above, the method and device for generating data according to the embodiments may generate the new data using each of the high-dimensional and the low-dimensional information as its constraint. For example, the conventional data generative model may be limited to generating the image while constraining the high-dimensional feature information. However, using the conventional model may be challenging because constraining the low-dimensional information, such as one pixel or several pixels, may lead to the model overfitting. On the other hand, the method and device according to the embodiments of the present disclosure, newly disclosed by adjusting the architecture of the generative model, may generate the data by constraining the high-dimensional information such as the implicit semantic information in the table-type data and by simultaneously constraining the sparse feature information, i.e., low-dimensional information, in the table-type data.

Although embodiments of the present disclosure have been described in detail hereinabove, the scope of the present disclosure is not limited thereto. In other words, various modifications and alterations made by those of ordinary skill in the art to which the present disclosure pertains by using a basic concept of the present disclosure as defined in the following claims also fall within the scope of the present disclosure.

What is claimed is:

1. A method for generating data, the method comprising:
generating a constraint vector variable specifying a constraint specific to the table-type data;
acquiring generated data by applying the constraint vector variable and a latent vector variable to a generator;
discriminating whether the generated data is real data or fake data by applying original data and the generated data to a discriminator;
predicting whether the generated data satisfies the constraint specific to the table-type data; and
generating a predicted constraint vector variable based on a prediction result,
wherein the method generates new data while constraining feature information unique to table-type data.

2. The method of claim 1, wherein acquiring the generated data includes:
converting the constraint vector variable to a low-dimensional vector through a first multilayer perceptron (MLP) embedding; and
converting the latent vector variable to the low-dimensional vector through a second MLP embedding.

3. The method of claim 2, wherein:
acquiring the generated data further includes additionally applying a feature vector variable to the generator together with the constraint vector variable; and
converting the constraint vector variable to the low-dimensional vector through the first MLP embedding includes converting the constraint vector variable and the feature vector variable to the low-dimensional vectors through the first MLP embedding.

4. The method of claim 2, wherein acquiring the generated data further includes:
expanding information on the low-dimensional vectors acquired from the first MLP embedding and the second MLP embedding; and
securing connectivity between the latent vector variable and the constraint vector variable.

5. The method of claim 4, wherein acquiring the generated data further includes:
calculating attention for each of a plurality of heads having different focusing aspects on a vector having expanded information through a multi-head attention network (MHAN); and
outputting a final result by combining attention results with each other.

6. The method of claim 5, wherein acquiring the generated data further includes:
generating a specific type of result by analyzing the final result; and
acquiring the specific type of result as the generated data.

7. The method of claim 1, wherein discriminating further includes performing frame reshaping reconstruction on the generated data.

8. The method of claim 7, wherein discriminating further includes:
calculating attention for each of a plurality of heads having different focusing aspects on the reconstructed generated data through a MHAN; and
outputting a final result by combining attention results with each other.

9. The method of claim 8, wherein discriminating further includes:
performing feature extraction and conversion through a MLP; and
discriminating whether the generated data is the real data or the fake data based on results of the feature extraction and conversion.

10. The method of claim 1, further comprising:
performing error measurement on the generated data and the predicted constraint vector variable through an error function based on mean squared error (MSE).

11. A device for generating data, wherein the device executes a program code loaded in at least one memory device by at least one processor and wherein the program code is executed to:
generate a constraint vector variable specifying a constraint specific to the table-type data;
acquire generated data by applying the constraint vector variable and a latent vector variable to a generator;
discriminate whether the generated data is real data or fake data by applying original data and the generated data to a discriminator;
predict whether the generated data satisfies the constraint specific to the table-type data; and
generate a predicted constraint vector variable based on a prediction result,
wherein the device generates new data while constraining feature information unique to table-type data.

12. The device of claim 11, wherein acquiring the generated data includes:
converting the constraint vector variable to a low-dimensional vector through a first multilayer perceptron (MLP) embedding; and
converting the latent vector variable to the low-dimensional vector through a second MLP embedding.

13. The device of claim 12, wherein acquiring the generated data includes:
additionally applying a feature vector variable to the generator together with the constraint vector variable; and
converting the constraint vector variable to the low-dimensional vector through the first MLP embedding includes converting the constraint vector variable and the feature vector variable to the low-dimensional vectors through the first MLP embedding.

14. The device of claim 12, wherein acquiring the generated data further includes:
expanding information on the low-dimensional vectors acquired from the first MLP embedding and the second MLP embedding; and
securing connectivity between the latent vector variable and the constraint vector variable.

15. The device of claim 14, wherein acquiring the generated data further includes:
calculating attention for each of a plurality of heads having different focusing aspects on a vector having expanded information through the multi-head attention network (MHAN); and
outputting a final result by combining attention results with each other.

16. The device of claim 15, wherein acquiring the generated data further includes:
generating a specific type of result by analyzing the final result; and
acquiring the specific type of result as the generated data.

17. The device of claim 11, wherein discriminating further includes performing frame reshaping reconstruction on the generated data.

18. The device of claim 17, wherein discriminating further includes:
calculating attention for each of a plurality of heads having different focusing aspects on the reconstructed generated data through a MHAN; and
outputting a final result by combining attention results with each other.

19. The device of claim 18, wherein discriminating further includes:
performing feature extraction and conversion through a MLP; and
discriminating whether the generated data is the real data or the fake data based on results of the feature extraction and conversion.

20. The device of claim 11, wherein the program code performs error measurement on the generated data and the predicted constraint vector variable through an error function based on mean squared error (MSE).
